(19) United States
(12) Patent Application Publication
(10) Pub. No.: US 2016/0273563 A1
(43) Pub. Date: Sep. 22, 2016

(54) Spring-biased wedge fastener

(71) Applicant: Loren Skarie, Vergas, MN (US)

(72) Inventor: Loren Skarie, Vergas, MN (US)

(21) Appl. No.: 14/545,054

(22) Filed: Mar. 19, 2015

(51) Int. Cl. F16B 2/14

(52) U.S. Cl. CPC F16B 2/14

(57) ABSTRACT

A fastener having head and stem housing portions and a cooperating wedge piece. A threaded control member and spring reciprocally direct longitudinal and lateral movement of the wedge piece. The wedge piece laterally expands and contracts relative to the stem portion at interlocking, tapered slot and raised flange/rib/rail slide surfaces to vary the relative lateral or transverse separation between gripping surfaces at the wedge piece and stem portion to engage and release the fastener and attached appliance from an aperture in a support surface.

### RELATED US APPLICATION DATA

Provisional application 61/967,615 filed Mar. 24, 2014.

### BACKGROUND OF THE INVENTION

The present invention relates to a fastener having head and stem portions reciprocally interconnected at a longitudinally directed slot and rail mounting to a resiliently biased wedge piece operable to expand and contract laterally to attach and detach the fastener at an aperture of a support surface.

The present fastener was developed to provide a means for attaching a variety of appliances and devices at through holes in support surfaces. The fastener can be designed to be integral with, interlock with or mount to a device to be secured. For example, a head piece of the fastener can be integrated into the device. The fastener independently mounts through an aperture at a support surface and operates to secure the device to the support. Projecting pieces of the fastener mount through the support surface aperture and expand/contract to provide a wedged fastening.

Fasteners of the foregoing general type have been adapted for use in automotive and other applications. Such fasteners provide arms/stems that inherently expand and contract due to the use of resilient materials and/or special body and stem/arm shapes. A fastener used to secure faucets and other appliances to countertops and having a pair of overlapping wedge or ramped pieces contained in a cooperating support housing is shown at U.S. Pat. No. 6,571,407.

In distinction to the fastener of the foregoing patent, the present improved fastener provides a body housing having head and stem portions and a longitudinally directable wedge piece interconnected thereto via a slot and rail. The head portion can be integrated into or interlock with a device to be supported. The head portion or combination exhibits a width wider than a mounting hole to which the fastener attaches. The stem portion is shaped to project through a mounting aperture in a support surface. The wedge piece cooperates with the stem portion to laterally or transversely expand and contract and fasten the device to the support surface.

### SUMMARY OF THE INVENTION

It is a primary object of the invention to provide a fastener having a housing including head and stem portions and a reciprocating wedge piece that cooperate to secure the fastener to an aperture at a support surface.

It is a further object of the invention to provide a housing having a head portion and a stem portion adapted or molded as part of a device or work object to be supported and a wedge-acting fastener piece that cooperates with a stem surface (e.g. flange, rail or rib) to collectively expand and contract to secure the fastener and supported device to an aperture at a support surface.

It is a further object of the invention to provide wedge piece that expands and contracts relative to the stem portion as it is longitudinally manipulated along a ramped surface (e.g. flange, rail or rib) of the stem piece oriented in a range of 15-45° relative to a longitudinal stem axis.

It is a further object of the invention to provide a control member fitted to the head portion and connected to the wedge piece that directs longitudinal movement of the wedge piece along the ramped surface to induce lateral or transverse movement of gripping surfaces at the wedge piece and stem portions of the fastener.

It is a further object of the invention to provide a fastener having a control member comprised of a threaded member and/or resilient member (e.g. a spring) adapted to longitudinally direct the wedge piece relative to the stem portion and laterally expand/contract the gripping surfaces.

It is a further object of the invention to provide a wedge piece having a slot interconnected to the stem portion at a raised rail or rib projecting at an acute angle to a longitudinal axis of the stem portion to contain the movement of the wedge piece within the stem portion.

It is a further object of the invention to provide a fastener wherein the shape of the housing head and stem portions are shaped to mate with support surfaces and through holes exhibiting a wide variety of sizes and shapes.

In a presently preferred fastener construction, a wedge piece is secured to the stem portion to move along a tapered surface projecting at an acute angle to a longitudinal axis of the stem portion to transversely expand and contract via the operation of a control member coupling the wedge piece to the stem portion. Movement of the control member directs a transverse or lateral movement of the wedge piece and/or resiliently biases the lateral expansion/contraction of the wedge piece relative to the longitudinal axis of the stem portion. Gripping surfaces at the wedge piece and stem portion grip and secure a device fitted to the fastener to the support surface.

The control member can comprise a threaded member or member with another type of interconnecting interface to the wedge piece that is reciprocally operable to longitudinally direct movement of the wedge piece and induce lateral or transverse expansion and contraction of the wedge piece toward or away from the stem portion. In a presently preferred fastener, a threaded member is mounted through the head portion and threaded to the wedge piece. A spring is concentrically mounted to the member to resiliently bias the wedge piece away from the stem portion. Other resilient or flexible appendages at the wedge piece and/or fitted between the wedge piece and head or stem portions can be adapted to facilitate the relative expansion/contraction between the wedge piece and stem portion to achieve a desired range of expansion and contraction.

The range of relative movement is determined by a cooperating slot and raised slide rail or rib at the wedge piece and stem portion. The slot and rail are oriented in a range of 15-45° relative to a longitudinal axis of the stem portion. The angularly directed slide surfaces are located and shaped to longitudinally cooperate and induce gripping surfaces at the wedge piece and stem portion to laterally or transversely expand and contract to vary the collective diameter or width.

In a mounting condition, the wedge piece is directed upward along the stem portion to reduce the collective diameter of the cooperating pieces. The wedge piece and stem portion when sufficiently retracted can be mounted through an aperture in a desired support surface.

Once mounted through the aperture, the threaded control member is manipulated to direct the stem piece downward and induce the tapered surfaces to laterally expand and hold the wedge piece away from the stem portion and induce the gripping surfaces to engage the aperture side walls and/or under side of the support surface. The threads at the control member prevent the fastener from being withdrawn from the aperture and whereby the interconnected device or work object (e.g. faucet) is secured to the support surface.

The foregoing objects, advantages and distinctions of the invention are obtained in alternative, presently preferred assemblies shown and described below. The disclosed and presently contemplated fastener and alternative combinations of features found therein represent several representative novel constructions and embodiments of the invention. Still other objects, advantages, distinctions, constructions and combinations of individual features of the invention are discussed and will become more apparent from the following description with respect to the appended drawings. Similar components and assemblies are referred to in the various drawings with similar alphanumeric reference characters. The description to each feature and/or combination should not be literally construed in limitation of the invention. Rather, the invention should be interpreted within the broad scope of the further appended claims.

### BRIEF DESCRIPTION OF THE DRAWINGS

FIG. 1 depicts the fastener as it appears in a fastened condition with the wedge piece expanded away from the stem portion at a support surface.

FIG. 2 depicts the fastener in dashed line removed from the mounting surface with the wedge piece retracted and in solid line in a fastened condition with the wedge piece extended.

FIG. 3 shows an exploded assembly view of the fastener with a housing cover of the head and stem portions removed and exposing the wedge piece, the cooperating slot and raised rail/rib surfaces, threaded control member and spring.

FIG. 4 shows a perspective view of the wedge piece and slide slot in the wedge piece that cooperates with a raised flange, rib or rail at the stem portion as the wedge piece is longitudinally manipulated relative to the stem portion and the longitudinal axis common to the stem portion and wedge piece.

FIG. 5 shows a perspective view of the wedge piece rotated to expose the slot from a different perspective.

FIG. 6 shows a perspective assembled view of the fastener integrated into an attached appliance (shown in partial section) with a housing cover of the head and stem portions removed to expose the wedge piece, threaded control member, spring and cooperation between the wedge piece slot and raised rail or rib at the stem portion.

### BRIEF DESCRIPTION OF THE PREFERRED EMBODIMENT

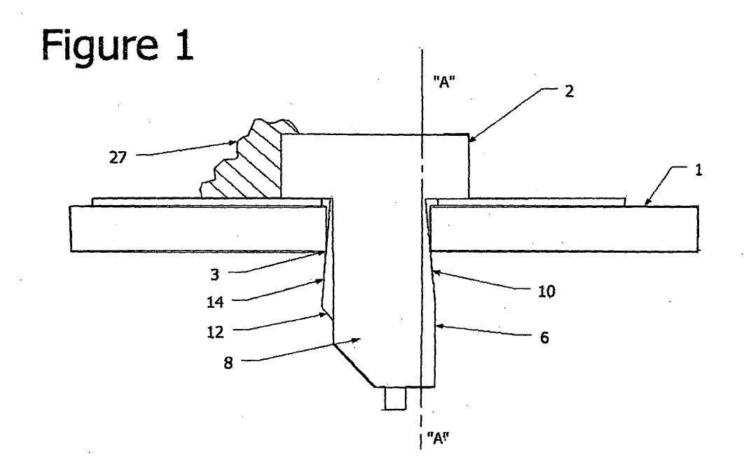

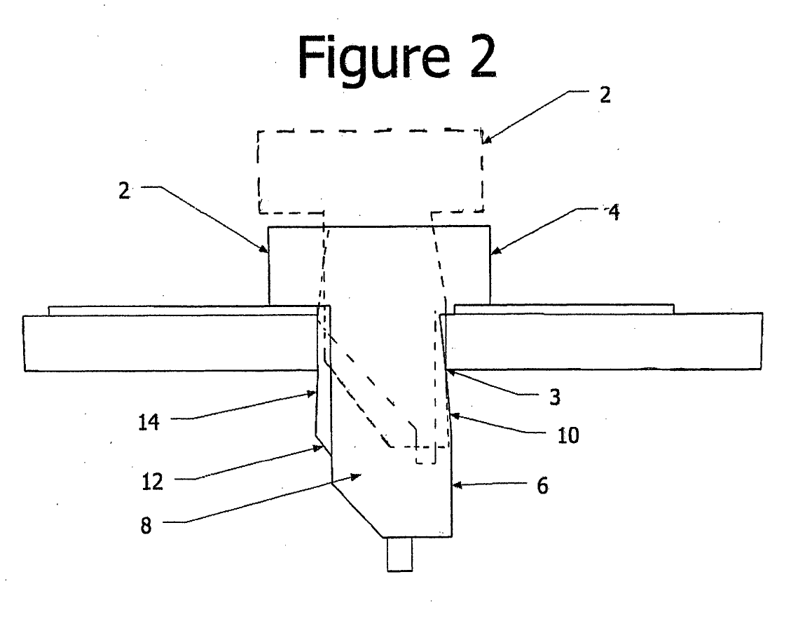

With attention to FIGS. 1 and 2 views are shown to the construction and mounting of one construction or configuration of the fastener 2 of the present invention through an aperture 3 of a support 1. The fastener 2 comprises a head portion 4 and a captured stem portion 6. The stem portion 6 projects from the head 4. A sidewall 8 of the stem portion 6 generally projects orthogonal to the head portion 4. A laterally displaced wedge or gripping sidewall surface 10 projects at an acute angle offset from a longitudinal housing axis “A” of the stem portion 6 in the range of 1-20°. A wedge piece 12 is captured to the stem portion and mounted to laterally or transversely expand and contract relative to the longitudinal axis “A”.

The gripping sidewall surface 10 is aligned and when the wedge piece 12 is laterally expanded, the canting at the surface 10 induces contact between the stem piece 6 and the bore of the aperture 3 and underside of the support surface 1. Correspondingly, when the wedge piece 12 is laterally expanded, its tapered gripping surface 14 similarly grips the bore of the aperture 3 and underside of the support surface 1. To facilitate the gripping action and fastener attachment, the external surfaces 10 and 14 of the stem portion 6 and wedge piece 12 can include knurling or other roughened, non-slip surface treatment(s).

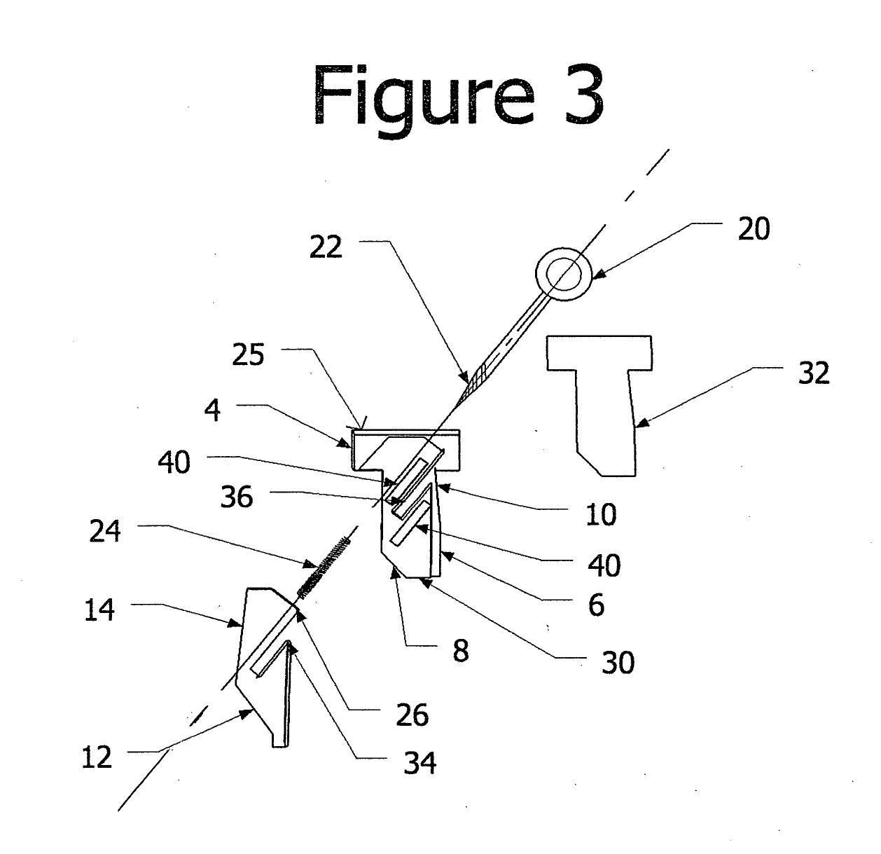

With additional attention to FIG. 3 and in typical use, the wedge piece 12 is elevated toward the head portion 4 and contracts toward the stem portion 6 to permit mounting the fastener 2 through an aperture 3 in a support surface 1. The length of the stem portion 6 is sized to assure complete penetration of the aperture 3. As the fastener 2 is engaged via a control member 20, presently comprised of a threaded stem piece 22 and coaxially aligned spring 24, the wedge piece 12 and gripping wall surface 14 expand laterally away from the stem portion 6 and the side wall gripping surfaces 14 and 10 engage the bore of the aperture 3.

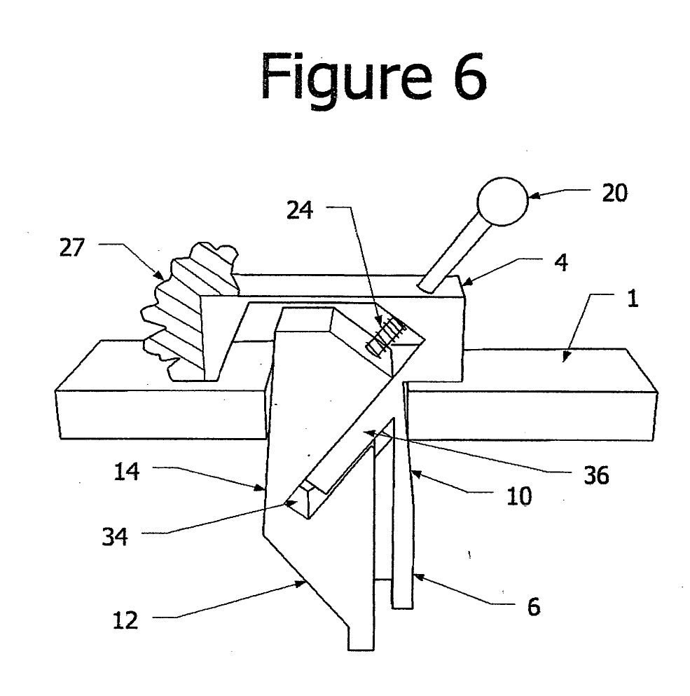

The stem piece 22 mounts through an open bore 25 in the head portion 4 and is threaded to a bore 26 in the wedge piece 12. The stem piece 22 rotates freely relative to the head portion 4. The spring 24 resiliently biases the wedge piece 12 away from the head and stem portions 4 and 6. The supported device or appliance 27 (shown in partial section at FIGS. 1 and 6 can comprise a faucet or other device or appliance that is attached to the head portion 4) is progressively drawn tight and secured to the support surface 1.

The head portion 4 alone or in combination with an attached device or appliance 27 thus exhibits a width greater than the widest portion of the aperture 3. The stem portion 6, in turn, and with the wedge piece 12 retracted to a mounting condition exhibits a width narrower that the narrowest width of the aperture 3 to facilitate insertion.

Although the fastener 2 depicted herein exhibits a planar shape having a nominal ¼-½ inch thickness, the head and stem portions 4 and 6 can be constructed to exhibit frusto-conical, cylindrical or any other appropriate geometric shapes. That is, the head and stem portions 4 and 6 can exhibit any desired regular or irregular 3-dimensional shapes compatible with the application and shapes of the aperture 3 and/or device or appliance 27 to be secured. The head and/or stem portions 4 and 6 can also include resilient appendages, projections or the like that radiate from the head and stem portions 4 and 6 to facilitate and/or maintain a preferred mounting application, attachment to the appliance 27 and orientation at the support 1 or appliance 27.

It is also to be appreciated that the fastener 2 and particularly the head portion 4 can be shaped to interlock with the fastened appliance 27. The head portion 4 can also be integrated into the casting or molding of the appliance 27. For example, the housing 30 and cover piece 32 that define the head and stem portions 4 and 6 can comprise one or more projections that project from the appliance 27 such as the base of a faucet, rack, shelving, bracket or other device that is normally mounted to a wall or horizontal surface. The head portion 4 can also mount in keyed cavities in the appliance 27. The appliance or work piece is thus readily secured to the support surface 1 upon aligning one or more projecting stem portions 6 with mating apertures 3 and engaging cooperating control members 20 to induce wedging actions at each fastener 2.

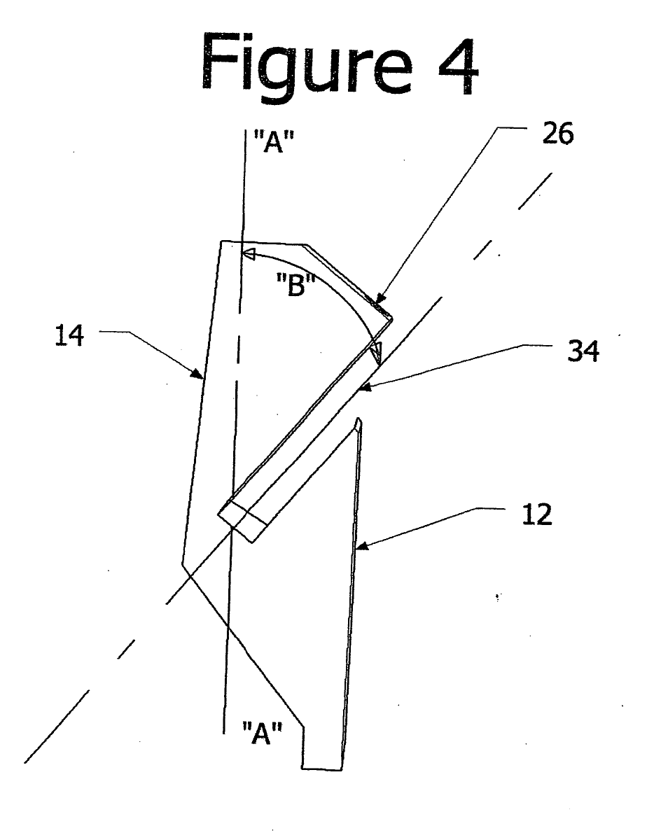

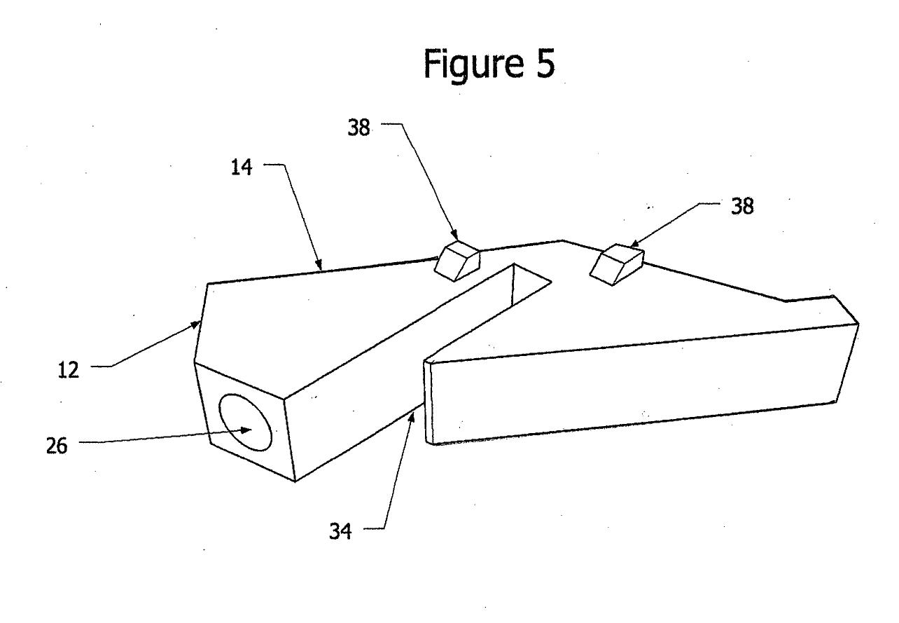

Returning attention to FIG. 3 and with additional attention to FIGS. 4, 5 and 6, details are provided to the construction of the wedge piece 12 and cooperative mounting relationship to the housing 30. Particularly to be appreciated is that the wedge piece 12 includes a slot 34 that captures a raised flange, rail or rib 36 that projects from the interior surface of the stem portion 6 away from the sidewall 10 at an acute angle “B” relative to the longitudinal axis of the stem portion 6, see FIG. 4.

Longitudinal movement of the wedge piece 12 is constrained to the rail or rib 36. The amount of lateral movement with rotation of the control member 20 is defined by the acute angle “B” between the centerline axis of the slot 34 and longitudinal stem axis “A”. The slot 34 and rail or rib 36 are preferably oriented at an angle “B” in a range of 15-45° relative to the longitudinal axis “A”. The particular angle is varied to promote fastener gripping depending upon the acute angular orientation of 1-20° established at the gripping surfaces 10 and 14 relative to the longitudinal axis “A”.

Longitudinal and lateral movement of the wedge piece 12 as directed via the control member 20 is thus restricted via the interconnection between the slot 34 and rail or rib 36. The longitudinal movement induces a relative lateral or transverse expansion or contraction of the wedge piece 12 relative to the stem portion 6 and longitudinal axis “A” of the housing 30. The laterally displaced gripping surfaces 10 and 14 correspondingly grip or disengage from the support surface 1. The gripping surfaces 10 and 14 can include knurling, projections, grooves or other surface preparations or compositions to facilitate a frictional gripping action.

Presently, the extension of the wedge piece 32 from the housing 30 induces an expansion and griping action of the surfaces 10 and 14. A retraction of the wedge piece 12 into the housing 30 induces a lateral contraction of the gripping surfaces 10 and 14. It is to be appreciated that the stem portion 6 and wedge piece 12 might be constructed to induce the wedge piece 12 to retract into the stem portion 6 when longitudinally extended and expand away from the stem portion 6 when drawn toward the head portion 4.

In lieu of or in combination with the groove 34 and rib or rail 36, proper movement of the wedge piece 12 relative to the housing 30 can also be assured via appendages 38 that project from front and/or rear faces of the wedge piece 12 and mount within slots 40 in the wall of the housing 30. The slots 40, like the slot 34, serve as guides to longitudinal and lateral movement of the wedge piece 12. In lieu of slots 40, grooves, channels or recesses might be formed in the housing 30 to cooperate with the appendages 38. Alternatively the housing 30 might include appendage(s) 38 that mate with additional slot(s), groove(s) or recess(es) at the wedge piece 12.

As discussed above, movement of the wedge piece 12 is directed with the control member 20. The spring 24 biases the wedge piece 32 away from the housing 30. It is to be appreciated that in certain fasteners, the spring 24 could be deleted. In other fasteners, the threaded stem 22 might be deleted in favor of only a spring 24 or other resilient element(s) that is mounted to promote a controllable longitudinal and lateral separation between the wedge piece 12 relative to the housing 30.

While the invention is shown and described with respect to one presently preferred assembly, several considered improvements, modifications and/or alternative features or combinations are also mentioned. Still other assemblies and arrangements may be suggested to those skilled in the art. It is to be appreciated that the features of the foregoing fastener assembly can be arranged in different combinations. The foregoing description should therefore be construed to include all those embodiments within the spirit and scope of the following claims.

What is claimed is:

1. A fastener assembly comprising:
a) a housing having a head portion and a stem portion that projects from said head portion, wherein said head portion exhibits a width greater than a width of said stem portion, wherein said stem portion includes a gripping surface adapted to grip a wall of a bore, and wherein said housing includes a tapered surface that extends at an acute angle relative to a longitudinal axis of said housing;
b) a wedge piece having a gripping surface adapted to grip a wall of a bore and a tapered surface that extends at an acute angle relative to said longitudinal axis of said housing and wherein the tapered surfaces of said housing and wedge piece are aligned such that longitudinal axial movement of one tapered surface over the other tapered surface induces a lateral expansion and contraction of the spacing between the gripping surfaces of said housing and wedge piece; and
c) a control member operative to direct axial movement of said wedge piece relative to said housing and the lateral expansion and contraction of the spacing between the gripping surfaces of said housing and wedge piece.

2. A fastener assembly as set forth in claim 1 wherein said control member comprises a threaded stem piece mounted through said housing and secured to said wedge piece to reciprocally direct said wedge piece relative to said housing.

3. A fastener assembly as set forth in claim 2 including a spring mounted to promote an axial separation of said housing relative to said wedge piece.

4. A fastener assembly as set forth in claim 1 wherein said wedge piece includes a slot and said housing includes a projecting rail mounted to move to and fro in said slot to contain the movement of said wedge piece relative to said stem portion.

5. A fastener assembly as set forth in claim 4 wherein said wedge piece includes a projecting appendage mounted to move to and fro in a slot, recess or groove at said housing.

6. A fastener assembly as set forth in claim 1 wherein said wedge piece includes a projecting appendage mounted to move to and fro in a slot, recess or groove at said housing.

7. A fastener assembly as set forth in claim 1 wherein said control member comprises a resilient member mounted to promote an axial separation of said housing relative to said wedge piece.

8. A fastener assembly as set forth in claim 1 wherein said head portion is configured as part of an appliance to be secured to a support surface by said fastener.

9. A fastener assembly as set forth in claim 1 wherein said head portion is configured to interlock with an appliance to be secured to a support surface by said fastener.

10. A fastener assembly as set forth in claim 1 wherein the laterally displaced tapered surfaces of said housing and wedge piece each project at an acute angle offset from the longitudinal housing axis in the range of 1-20°.

11. A fastener assembly as set forth in claim 1 including an appliance affixed to said head portion and a support surface having a bore sized to permit the insertion of said stem portion and wedge piece therein and wherein upon mounting said stem portion and wedge piece into the bore and directing the lateral separation of said gripping surfaces the appliance is fastened to the support surface.

12. A fastener assembly comprising:
a) a housing having a head portion and a stem portion that projects from said head portion, wherein said head portion exhibits a width greater than a width of said stem portion, and wherein said housing includes a tapered surface adapted to grip a wall of a bore that extends at an acute angle relative to a longitudinal axis of said housing;
b) a wedge piece having a tapered surface adapted to grip a wall of a bore that extends at an acute angle relative to said longitudinal axis of said housing and wherein the tapered surfaces of said housing and wedge piece are aligned such that longitudinal axial movement of one tapered surface relative to the other tapered surface induces a lateral expansion and contraction of the spacing between the gripping surfaces of said housing and wedge piece; and
c) a control member operative to direct axial movement of said wedge piece relative to said housing and the lateral expansion and contraction of the spacing between the gripping surfaces of said housing and wedge piece.

13. A fastener assembly as set forth in claim 12 wherein the laterally displaced tapered surfaces of said housing and wedge piece each project at an acute angle offset from the longitudinal housing axis in the range of 1-20°.

14. A fastener assembly as set forth in claim 12 wherein said control member comprises a threaded stem piece mounted through said housing and secured to said wedge piece to reciprocally direct said wedge piece relative to said housing and including a spring mounted to promote an axial separation of said housing relative to said wedge piece.

15. A fastener assembly as set forth in claim 12 wherein the laterally displaced tapered surfaces of said housing and wedge piece each project at an acute angle offset from the longitudinal housing axis in the range of 1-20°.

16. A fastener assembly as set forth in claim 12 wherein said wedge piece includes a slot and said housing includes a projecting rail mounted to move to and fro in said slot to contain the longitudinal and lateral movement of said wedge piece relative to said stem portion.

17. A fastener assembly comprising:
a) a housing having a head portion and a stem portion that projects from said head portion, wherein said head portion exhibits a width greater than a width of said stem portion, and wherein said housing includes a tapered surface adapted to grip a wall of a bore that extends at an acute angle relative to a longitudinal axis of said housing;
b) a wedge piece having a tapered surface adapted to grip a wall of a bore that extends at an acute angle relative to said longitudinal axis of said housing, wherein said wedge piece includes a slot and said housing includes a projecting rail mounted to move to and fro in said slot to contain the movement of said wedge piece relative to said stem portion and wherein the tapered surfaces of said housing and wedge piece are aligned such that longitudinal axial movement of one tapered surface relative to the other tapered surface induces a lateral expansion and contraction of the spacing between the gripping surfaces of said housing and wedge piece; and
c) a control member comprising a threaded stem piece mounted through said housing and secured to said wedge piece to reciprocally direct movement of said wedge piece relative to said housing and the lateral expansion and contraction of the spacing between the gripping surfaces of said housing and wedge piece.

18. A fastener assembly as set forth in claim 17 wherein the laterally displaced tapered surfaces of said housing and wedge piece each project at an acute angle offset from the longitudinal housing axis in the range of 1-20°.

19. A fastener assembly as set forth in claim 17 including an appliance affixed to said head portion and a support surface having a bore sized to permit the insertion of said stem portion and wedge piece therein and wherein upon mounting said stem portion and wedge piece into the bore and directing the lateral separation of said gripping surfaces the appliance is fastened to the support surface.
